(19) United States
(12) Patent Application Publication
(10) Pub. No.: US 2006/0286887 A1
(43) Pub. Date: Dec. 21, 2006

(54) Method and installation for producing a nonwoven fabric exhibiting good properties of tensile resistance

(76) Inventor: Frederic Noelle, Saint Nazaire les Eymes (FR)

Correspondence Address: PEARNE & GORDON LLP, 1801 EAST 9TH STREET, SUITE 1200, CLEVELAND, OH, 44114-3108, US

(21) Appl. No.: 10/529,842

(22) PCT Filed: Oct. 10, 2003
(86) PCT No.: PCT/FR03/02989

§ 371 Date: Mar. 31, 2005

(30) Foreign Application Priority Data
Oct. 11, 2002 (FR) 02 12653

(51) Int. Cl. B29C 41/24; D04H 3/16; D04H 1/46

(52) U.S. Cl. 442/401; 442/408; 264/165

(57) ABSTRACT

The invention concerns an installation for producing a nonwoven fabric comprising a spun bond lathe depositing a web of filaments on a first conveyor, the mat being consolidated on a first mobile element by entangling means. The invention is characterized in that it comprises means for passing, without any change in ratio, the mat of filaments on a first mobile element whereon the mat is consolidated by hydro-entangling means.

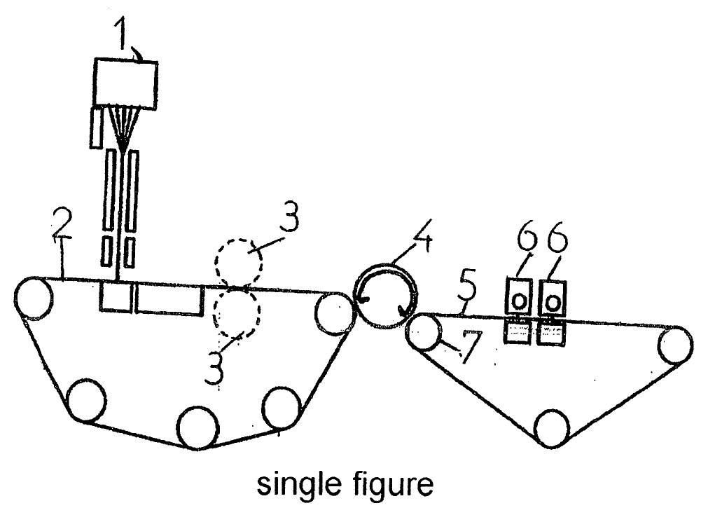

The present invention relates to methods and installations for the production of nonwoven fabrics. The invention relates more particularly to the production of nonwoven fabrics with the aid of a spun-bonding tower depositing a mat of filaments onto a first conveyor.

In the spun-bonding art, a very loose mat which is deposited onto a first conveyor is consolidated by compression and fusion in a calender. Fusion impairs the material so that the mat has less strength and a more plastic feel. Fusion densities the material and makes it rigid. Chemical binding involves the addition of costly chemical products which are not desirable for some applications.

The U.S. Pat. No. 3,485,706 has already described a method and an installation in which the mat of filaments which is deposited onto a first conveyor of a spun-bonding tower is consolidated by water-jet entanglement means.

The invention improves the method and installation described in U.S. Pat. No. 3,485,706 by making it possible to obtain an unwoven fabric having better properties.

The subject of the invention is, therefore, a method for preserving the ratio of the tensile strength in the length direction to the tensile strength in the breadth direction of a mat of filaments which is in displacement, characterized in that the mat is subjected to a vacuum, at the same time being applied to a support during the passage from a conveyor to a movable element.

The movable element may be a second conveyor or a cylinder or a hollow drum.

It has now been understood that it was not necessary to use the conveyor, onto which the mat of filaments which is in displacement is deposited from the spun-bonding tower, as a movable element on which the entanglement of the filaments by means of pressurized water jets takes place. The mat being consolidated, which is to be entangled by the entanglement means, catches in the meshes of the conveyor which are too large, so that the nonwoven fabric finally obtained has marks which make it unfit for sale. Entanglement is likewise of lower quality on account of this catching and because of the structure of the movable element. The idea therefore was to change conveyors, adopting a more air-permeable conveyor as the first conveyor and a less air-permeable conveyor or cylinder for carrying out consolidation by entanglement with the aid of water jets. However, it became clear that the passage from a conveyor to this movable element was detrimental to the properties of the nonwoven fabric and, in particular, caused the ratio of the tensile strength in the length direction to the tensile strength in the breadth direction of the nonwoven fabric to be poorer than that of the mat of filaments which came from the spun-bonding tower. Consequently, now, according to the invention, the mat is passed from the first conveyor to the movable element, at the same time being subjected to a vacuum applying it to a support. By this means, the ratio of the tensile strength in the length direction to the tensile strength in the breadth direction of the mat of filaments which is in displacement is preserved in the nonwoven fabric finally obtained after consolidation.

According to one embodiment, this ratio can even be improved by imparting to the support, which is in the form of a second movable element, a lower linear speed than that of the first conveyor.

The invention is also aimed at an installation for producing a nonwoven fabric, comprising a spun-bonding tower depositing a mat of filaments onto a first conveyor, the mat being delivered on a first movable element to means for consolidation by entanglement. According to the invention, means are provided which are intended for causing the mat of filaments to pass onto the first movable element, without modifying the ratio of the tensile strength in the length direction to the tensile strength in the breadth direction of said mat.

Said means may comprise, in particular, a second movable element having devices for the application of a vacuum which maintains the mat on the outer surface of the second movable element.

The second movable element may be a drum or a conveyor.

The first conveyor is more air-permeable than the first movable element. The first conveyor has, for example, an air permeability of 500 to 1100 CFM (cubic feet per minute) (14.1 m³/min to 31 m³/min), while the second movable element has an air permeability of 50 to 500 (1.41 m³/min to 14.1 m³/min).

The first conveyor (2) is generally a double or triple layer synthetic cloth with antistatic properties and high roughness. The second movable element (5) is a single layer synthetic or metallic cloth with linen, twill or satin reinforcement and with low roughness.

Preferably, the first conveyor has a greater roughness than the second movable element.

According to a particularly estimable embodiment, the first conveyor delivers the mat directly to the means intended for causing the mat of filaments to pass onto the first movable element. The term “directly” is understood, in particular, to mean that there is no interposition of a calender.

The invention is aimed, finally, at the use of a method or an installation according to the invention for preserving the ratio of the tensile strength in the length direction to the tensile strength in the breadth direction of a mat of filaments which is in displacement.

The air-permeability is measured as follows:

the permeability measurement is carried out on a permeability meter PX 3300 sold by the company TEXTEST;

the cloth sample is placed on the measuring head of the appliance;

the air-permeability value is given directly by the appliance in CFM for a pressure differential of 100 pascal;

the value retained is the average of 5 measurements.

The single FIGURE of the appended drawing illustrates the invention.

The single FIGURE is a diagrammatic view of an installation for producing a nonwoven fabric. It comprises a spun-bonding tower 1. A spun-bonding tower comprises a device for the extrusion of polymers, in particular a polypropylene or a polyester, which emerges in a spinneret providing filaments of polymers which are subsequently cooled in a cooling device, then, still in the downward direction, drawn in a drawing device and deposited in the form of a mat onto a first endless conveyor 2 having good air permeability and relatively high roughness, in such a way that the filaments are deposited onto its surface without slipping. The upper strand of the conveyor 2, onto which the mat of filaments is deposited, passes into the nip between two presser rollers 3 forming a compacting device. These presser rollers have been illustrated by dashes in this FIGURE since they are optional. At the exit of the first conveyor 2, the mat passes onto a hollow drum 4 (second movable element), within which a vacuum prevails, so that the mat is applied to the lower part of the drum 4 and so that the properties of the mat are not modified, as would be the case if it passed directly from one conveyor to another, with the resulting tensile phenomena. At the exit of the drum 4, the mat is taken up again by a conveyor 5 (first movable element) and passes under devices 6 for consolidation by the projection of water jets with a diameter of between 50 and 250 microns and under a pressure of between 20 and 1000 bar, and water is projected onto the mat by these devices 6, thereby entangling the fibers. The conveyor 5 is less air-permeable than the conveyor 2.

That return roller 7 of the conveyor 5 which is nearest to the suction cylinder 4 may itself be equipped with suction to facilitate the passage of the mat from the drum 4 to the conveyor 5.

In one embodiment, the drum 4 rotates counterclockwise at a lower linear speed than the displacement speed of the conveyor 2 from left to right in the FIGURE.

1. A method for preserving the ratio of the tensile strength in the length direction to the tensile strength in the breadth direction of a mat of filaments which is in displacement, passing from one conveyor to another, characterized in that the mat is subjected to a vacuum applying it to a support during the passage from the first conveyor to a movable element.

2. The method as claimed in claim 1, characterized in that the mat is slowed while it passes from the first conveyor to the movable element.

3. The method as claimed in claim 1, characterized in that the first conveyor is that onto which the filaments for forming the mat are deposited.

4. An installation for producing a nonwoven fabric, comprising a spun-bonding tower depositing a mat of filaments onto a first conveyor, the mat being delivered on a first movable element to means for consolidation by entanglement, and means intended for causing the mat of filaments to pass onto the first movable element, characterized in that the means intended for causing the mat of filaments to pass onto the first movable element comprise a second movable element having a device for the application of a vacuum which maintains the mat on the outer surface of the second movable element.

5. The installation as claimed in claim 4, characterized in that the second movable element is a drum or a conveyor.

6. The installation as claimed in claim 4, characterized in that the first conveyor is more air-permeable than the first movable element.

7. The installation as claimed in claim 6, characterized in that the first conveyor has an air permeability of between 500 and 1100 CFM (14.1 and 31 m3/min).

8. The installation as claimed in claim 5, characterized in that the first movable element has an air permeability of between 50 and 500 CFM (1.41 and 14.1 m3/min).

9. The installation as claimed in claim 4, characterized in that the first conveyor is a multilayer cloth, while the first movable element is a single layer cloth.

10. The installation as claimed in claim 4, characterized in that the first conveyor delivers the mat directly to the means intended for causing the mat of filaments to pass.

11. The installation as claimed in claim 4, characterized in that the first movable element has a suction device which cooperates with the means for causing the mat to pass, in order to facilitate the passage of the mat from the means to the first movable element.

12. The use of a machine as claimed in claim 4, for preserving the ratio of the tensile strength in the length direction to the tensile strength in the breadth direction of a mat of filaments which is in displacement, coming from a spun-bonding tower and going to a device for consolidation by means of water jets.
